(19) United States
(12) Patent Application Publication
(10) Pub. No.: US 2026/0005544 A1
(43) Pub. Date: Jan. 1, 2026

(54) INTEGRATING FIBER SENSING AND ADVANCED GRID ANALYSIS FOR PROACTIVE GRID RESILIENCE

(71) Applicant: NEC Laboratories America, Inc., Princeton, NJ (US)

(72) Inventors: Yangmin DING, East Brunswick, NJ (US); Ting WANG, West Windsor, NJ (US); Md Zahidul ISLAM, Bayonne, NJ (US)

(73) Assignee: NEC Laboratories America, Inc., Princeton, NJ (US)

(21) Appl. No.: 19/256,188

(22) Filed: Jul. 1, 2025

Related U.S. Application Data
(60) Provisional application No. 63/666,280, filed on Jul. 1, 2024.

(51) Int. Cl. H02J 13/00; H02J 3/00

(52) U.S. Cl. CPC H02J 13/00017; H02J 3/0012; H02J 3/0073; H02J 13/00002

(57) ABSTRACT

Disclosed are integrated DFOS systems and methods that advantageously integrates fiber sensing technology with advanced grid analysis to enhance the resilience of electrical distribution systems by providing accurate and efficient risk assessments. Utilizing real-time observations from Distributed Fiber Optic Sensing (DFOS), it accurately evaluates risks associated with probable events and calculates the risk of line failures. The method develops a modified risk-aware system that incorporates minimized system loss, voltage violations, power flow violations, the number of switching operations, and radiality constraints. By integrating DFOS data with existing grid data, the method enables rapid system adaptation and localized fault detection, advancing the state of the art in grid resilience and reliability.

### CROSS-REFERENCE TO RELATED APPLICATIONS

This application claims the benefit of U.S. Provisional Patent Application Ser. No. 63/666,280 filed Jul. 1, 2024, the entire contents of which is incorporated by reference as if set forth at length herein.

### FIELD OF THE INVENTION

This application relates generally to electricity distribution management and maintenance. More particularly, it pertains to advanced electrical grid analysis for proactive grid resilience via integrated distributed fiber optic sensing.

### BACKGROUND OF THE INVENTION

Distributed Fiber Optic Sensing (DFOS) is a rapidly emerging technology that uses fiber optic cables to detect environmental conditions affecting the fiber optic cables such as acoustic or other mechanical vibrations, and temperature. It has a wide range of applications due to its unique capabilities. Its ability to detect small vibrations and slight changes in temperature over long distances in real-time makes it a valuable tool for monitoring and protecting infrastructure elements including electrical distribution facilities.

Existing methods for managing and enhancing resilience of electrical distribution facilities are known to provide inaccurate risk assessment with respect to the electrical distribution facilities as they oftentimes rely on arbitrary risk assignments without clear rationale or derivation. Such lack of precise risk evaluation leads to inadequate system resilience planning and potentially ignores areas of the distribution facilities that require more immediate attention of service personnel or planners.

Additionally, contemporary methods that employ linear programming methodologies for adapting the electrical distribution system are known to be inherently time-consuming, making them impractical for emergency situations that may result from environmental or other disasters when rapid system preparation and response are crucial. Such delay in system adaption may result in prolonged outages and reduced reliability during critical times.

### SUMMARY OF THE INVENTION

An advance in the art is made according to aspects of the present disclosure directed to integrated DFOS systems, methods, and structures that advantageously—and in sharp contrast to the prior art integrates fiber sensing technology with advanced grid analysis to enhance the resilience of electrical distribution systems by providing accurate and efficient risk assessments.

Utilizing real-time observations from Distributed Fiber Optic Sensing (DFOS), it accurately evaluates risks associated with probable events and calculates the risk of line failures. The invention develops a modified risk-aware system that incorporates minimized system loss, voltage violations, power flow violations, the number of switching operations, and radiality constraints. By integrating DFOS data with existing grid data, the method enables rapid system adaptation and localized fault detection, advancing the state of the art in grid resilience and reliability.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative overview of an electrical distribution system with vulnerable lines according to aspects of the present disclosure.

FIG. 3 is a schematic diagram showing an illustrative combining of DFOS and grid data for coordinated system adaptation against faults and risks according to aspects of the present disclosure.

FIG. 4 is a schematic diagram showing an illustrative conventional system topology without risk avoidance (left) and adapted system topology resilient against risk (right) after resilient design transformation according to aspects of the present disclosure.

FIG. 5 is a scatter plot showing illustrative power flow through risky electrical power lines for two cases according to aspects of the present invention.

FIG. 6 is a plot showing illustrative system voltages and corresponding range according to aspects of the present disclosure.

FIG. 7 shows illustrative features in hierarchical format of our inventive approach, according to aspects of the present invention.

FIG. 8 is a schematic flow diagram showing illustrative flow of our inventive method according to aspects of the present disclosure.

FIG. 9 is a schematic diagram showing illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

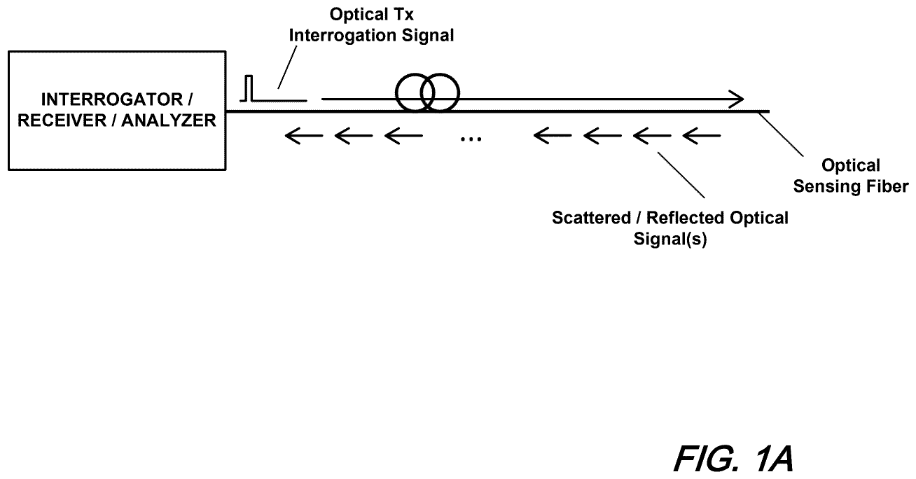

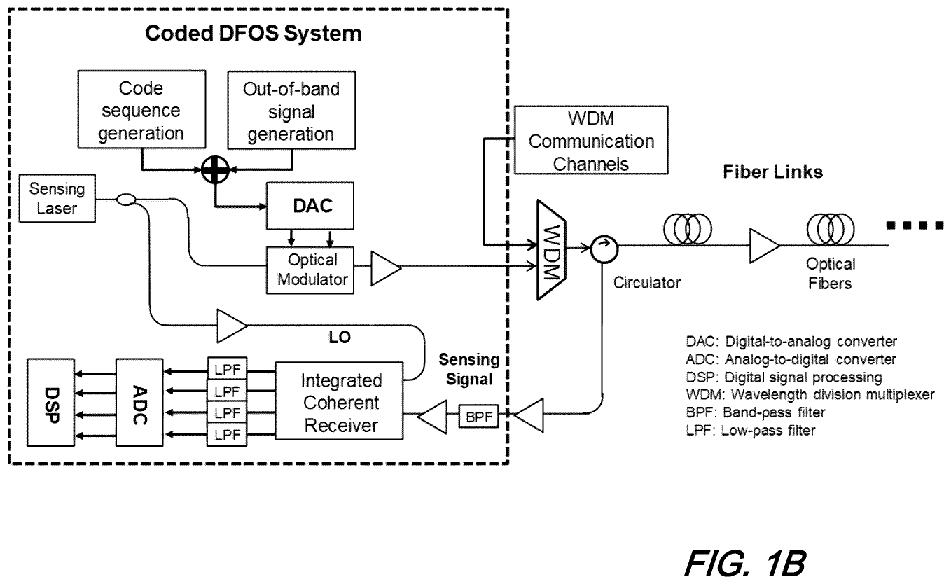

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

According to aspects of the present disclosure, we introduce an innovative Distributed Fiber Optic Sensing (DFOS) technology that may advantageously utilizes existing telecommunications infrastructure networks.

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

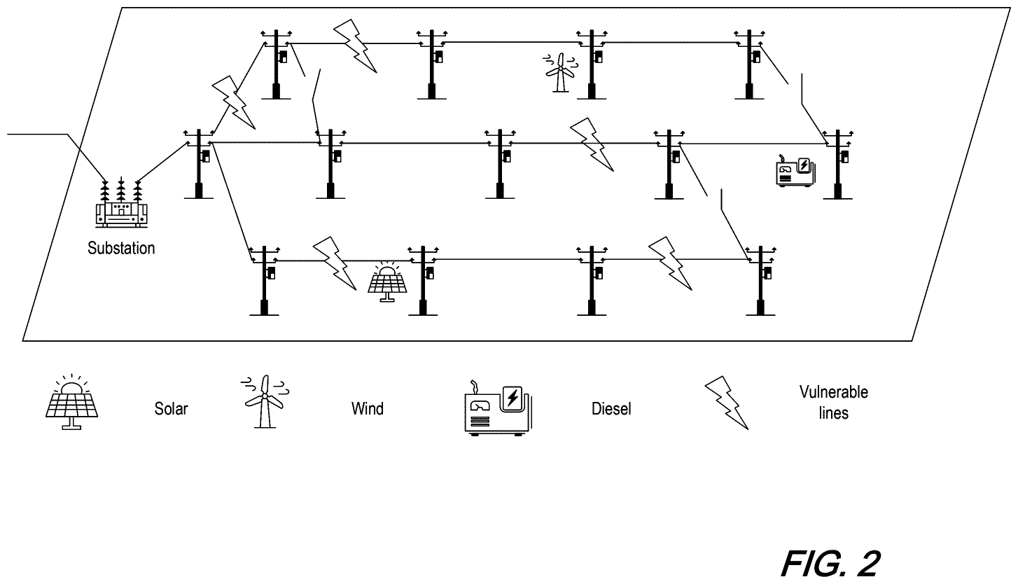

FIG. 2 is a schematic diagram showing an illustrative overview of an electrical distribution system with vulnerable lines according to aspects of the present disclosure.

As we have noted previously, the present invention addresses significant shortcomings in existing methods for managing and enhancing the resilience of electrical distribution systems, by integrating distributed fiber optic sensing and advanced grid analysis. As those skilled in the art will readily understand and appreciate, current approaches to resilience management and enhancement exhibits several critical drawbacks:

### Inaccurate Risk Assessment:

Existing approaches to management and enhancement of resilience of electrical distribution systems fail to provide accurate risk assessments for different zones or lines within the distribution system. These methods often rely on arbitrary risk assignments without a clear rationale or derivation. This lack of precise risk evaluation leads to inadequate system resilience planning and potentially overlooks areas that require more attention.

### Time-Consuming Adaptation Solutions:

Traditional methods employ integer linear programming-based solutions for adapting the distribution system. However, these solutions are inherently time-consuming, making them impractical for use during disaster conditions when rapid system preparation and response are crucial. The delay in system adaptation can result in prolonged outages and reduced reliability during critical times.

Our inventive systems and methods according to aspects of the present disclosure advantageously solve these problems by providing a more accurate and efficient method for enhancing the resilience of electrical distribution systems.

Our innovative approach integrates fiber sensing technology with advanced grid analysis to enhance the resilience of electrical distribution systems by providing accurate and efficient risk assessments. Utilizing real-time observations from Distributed Fiber Optic Sensing (DFOS), it accurately evaluates risks associated with probable events and calculates the risk of line failures. The invention develops a modified risk-aware system that incorporates minimized system loss, voltage violations, power flow violations, the number of switching operations, and radiality constraints. By integrating DFOS data with existing grid data, the method enables rapid system adaptation and localized fault detection, advancing the state of the art in grid resilience and reliability.

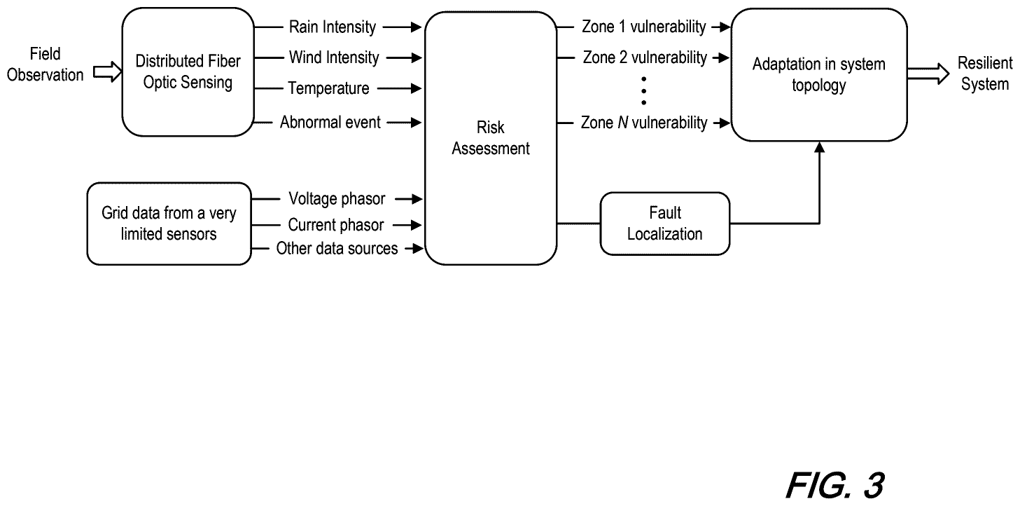

FIG. 3 is a schematic diagram showing an illustrative combination of DFOS and grid data for coordinated system adaptation against faults and risks according to aspects of the present disclosure.

The inventive method illustrated in FIG. 3 localizes faults by combining grid and DFOS data. Note that only one data source is insufficient for this system reconfiguration strategy. As the grid has a very limited number of sensors disposed in the grid, existing methods cannot successfully provide for fault localization and system adaptation.

### Limitations of Existing Fault Localization Methods

As those skilled in the art will understand and appreciate, three method types are available for fault localization.

Impedance-based methods: Impedance-based methods require exact information on system parameters, which may not be available to the utilities or inaccurate as these parameters change for many reasons, i.e., system modification, weather, etc.

Traveling wave-based methods: Traveling wave-based methods send high frequency waves along the power lines and sense reflected waves for fault localization. Although these methods work great in transmission systems, it results in inaccuracies in distribution systems as the system has many laterals.

Learning-based methods: Learning-based methods utilize sensor data throughout the grid to localize faults. These methods, however, require large numbers of sensors in the system to accurately localize the faults.

As we shall show and describe methods according to aspects of the present disclosure utilize DFOS data for event detection and integrate grid data to differentiate between an abnormal event and fault in the system. Our inventive methods only consider existing grid data at substations or at any major locations in the grid without placing any more sensors.

By integrating fiber sensing technology and advanced grid analysis to enhance the resilience of electrical distribution systems, our inventive methods provide accurate and efficient risk assessments. Particularly innovative features include the following.

Accurate Risk Assessment: Our innovative approach features an advanced method for accurately assessing the risks associated with probable events. By utilizing real-time observations from Distributed Fiber Optic Sensing (DFOS), it evaluates environmental factors such as rain intensity, wind intensity, temperature, and abnormal events to calculate the risk of line failures. This precise risk assessment ensures better-informed decisions for system resilience planning.

Integration of DFOS and Grid Data: Our innovative approach integrates DFOS data with existing grid data to provide a comprehensive understanding of both risks and fault scenarios. This combined data approach enhances the system's ability to differentiate between abnormal events and actual faults, enabling more effective and accurate responses.

Risk-aware System Reconfiguration: Our innovative approach develops a modified risk-aware system that incorporates key operational constraints such as minimized system loss, voltage violations, power flow violations, the number of switching operations, and radiality constraints. This ensures the system is prepared beforehand to minimize the impact of probable failures, enhancing the overall resilience of the electrical distribution system.

Rapid System Adaptation: Our innovative approach provides quick adaptation of the distribution system during disaster conditions by avoiding time-consuming computational methods. This rapid system preparation ensures that electricity supply can be maintained or quickly restored in vulnerable areas, reducing outage impacts on consumers.

Localized Fault Detection: By combining DFOS and grid data, our innovative approach localizes faults more effectively than traditional methods. It addresses the limitations of impedance-based, traveling wave-based, and learning-based fault localization methods, providing a more accurate and reliable solution without the need for additional sensors throughout the grid.

These features collectively contribute to solving the problem by enhancing the accuracy and efficiency of risk assessments, integrating comprehensive data sources for better fault detection, and enabling rapid and effective system adaptation to maintain resilience and reliability in the face of potential failures

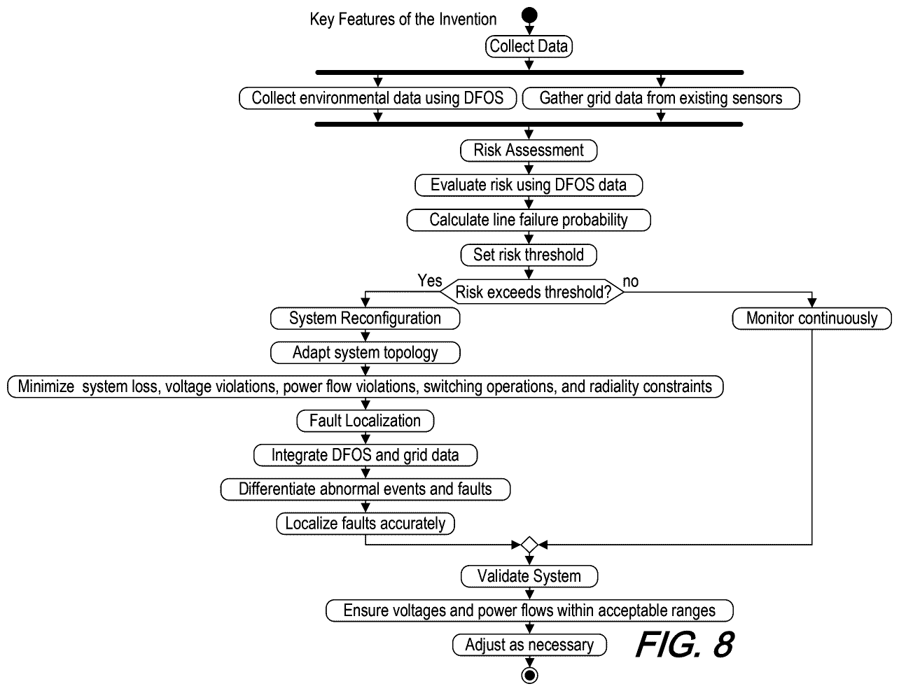

FIG. 8 is a schematic flow diagram showing illustrative flow of our inventive method according to aspects of the present disclosure.

### Field Observation

Collect environmental data in real-time using Distributed Fiber Optic Sensing (DFOS). This includes observations of rain intensity, wind intensity, temperature, and detection of abnormal events around the power lines.

### Data Collection

Gather real-time data from the existing limited grid sensors, including voltage phasor, current phasor, and other relevant data sources.

### Risk Assessment

Utilize the collected DFOS data to evaluate the risk associated with different zones or lines within the electrical distribution system.

Calculate the probability of line failures based on the intensity and duration of environmental factors.

Continuously update the risk assessment every few minutes to reflect the latest conditions.

### Threshold Setting

Set a risk intensity and duration threshold to determine when the system should be reconfigured.

This threshold can be dynamically adjusted based on ongoing risk assessments and observed data.

### System Reconfiguration

If the calculated risk exceeds the set threshold, initiate a pre-fault system reconfiguration to avoid high-risk zones.

Develop a modified risk-aware system topology that minimizes system loss, voltage violations, power flow violations, the number of switching operations, and radiality constraints.

### Adaptation in System Topology

Adapt the distribution system topology to reroute power flow away from high-risk zones, ensuring enhanced resilience against potential failures.

Utilize the combined DFOS and grid data to ensure that the system modification maintains operational requirements and stability.

### Fault Localization

Integrate DFOS data with existing grid data to accurately differentiate between abnormal events and actual faults.

Localize faults more effectively by using a combined data approach, addressing the limitations of impedance-based, traveling wave-based, and learning-based fault localization methods without the need for additional sensors.

### System Validation

Ensure that the adapted system topology meets operational requirements, with voltages and power flows remaining within acceptable ranges.

Continuously monitor and validate the system's performance, making further adjustments as necessary to maintain resilience and reliability.

### Example Scenario: High-Risk Line Failure

### Initial Configuration

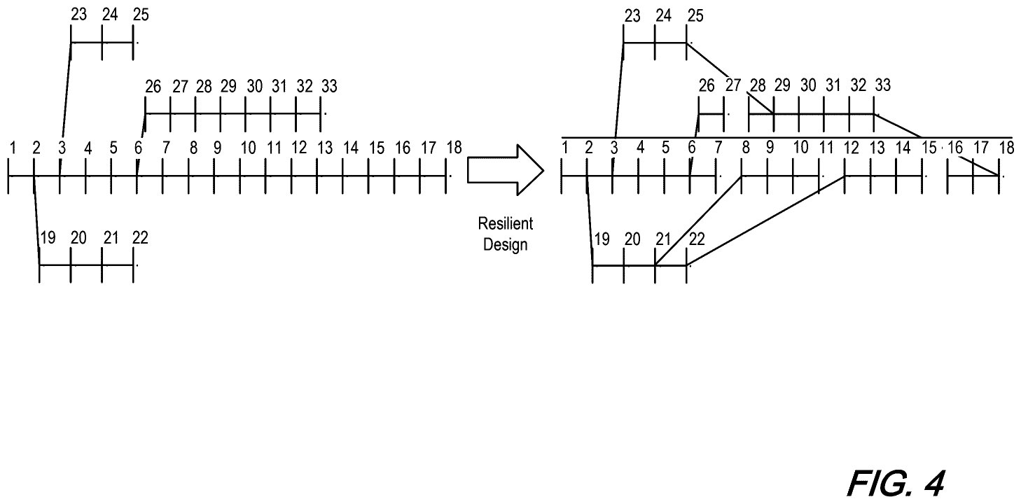

The original system configuration is as shown in FIG. 4, where utilities are unaware of any risks associated with the lines.

FIG. 4 is a schematic diagram showing an illustrative conventional system topology without risk avoidance (left) and adapted system topology resilient against risk (right) after resilient design transformation according to aspects of the present disclosure.

### Risk Detection

DFOS data indicates a high risk of failure for line (5-6) based on observed environmental conditions.

### Pre-Fault Reconfiguration

The system is reconfigured to avoid the high-risk line (5-6), resulting in the adapted topology shown in FIG. 4.

### Failure Occurrence:

If line (5-6) fails, the nearest recloser device opens, minimizing the outage area to only poles/buses 5, 6, 7, 26, and 27, as opposed to the larger outage area in the original configuration.

### System Performance:

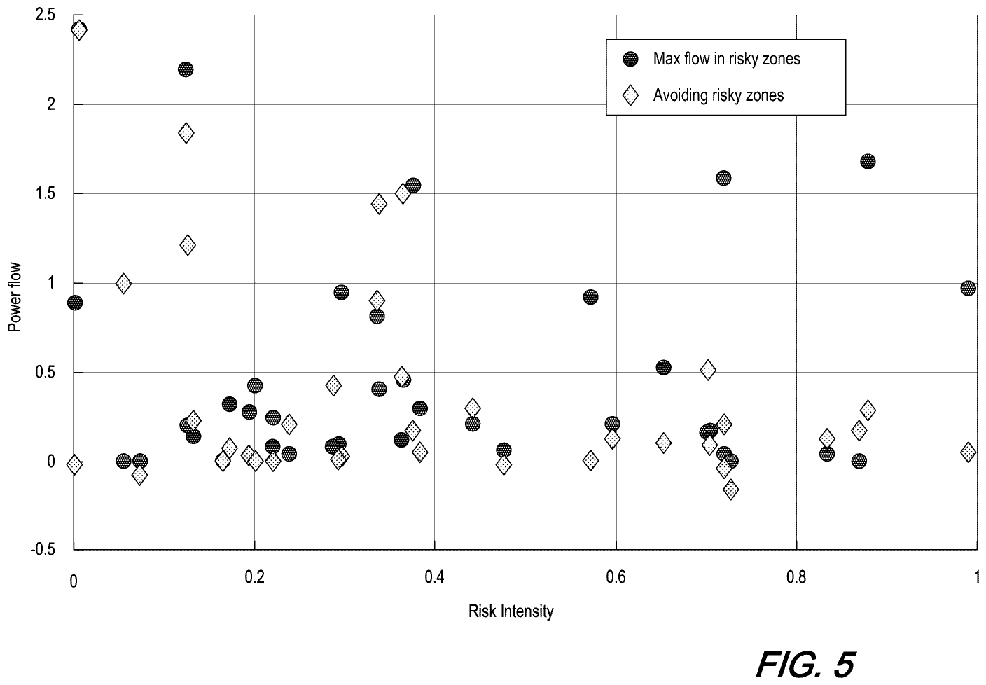

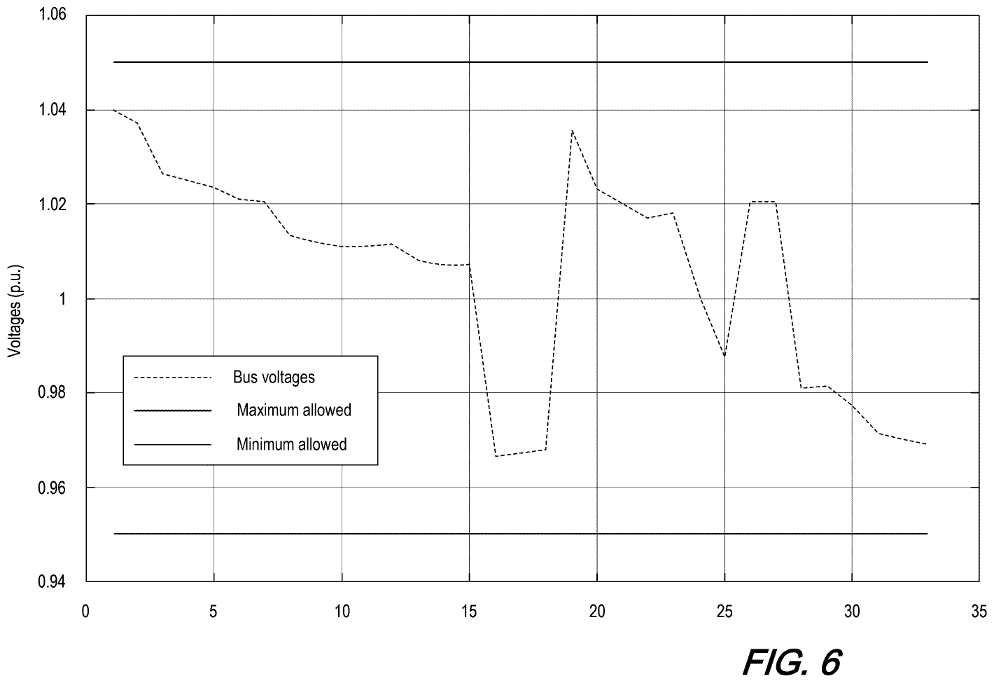

FIG. 5 shows reduced power flow through risky lines in the adapted design, and FIG. 6 confirms that system voltages remain within the allowed range.

FIG. 5 is a scatter plot showing illustrative power flow through risky electrical power lines for two cases according to aspects of the present invention.

FIG. 6 is a plot showing illustrative system voltages and corresponding range according to aspects of the present disclosure.

By following these steps, the invention enhances the resilience of electrical distribution systems, providing accurate risk assessments, efficient system reconfiguration, and effective fault localization to maintain reliable power supply

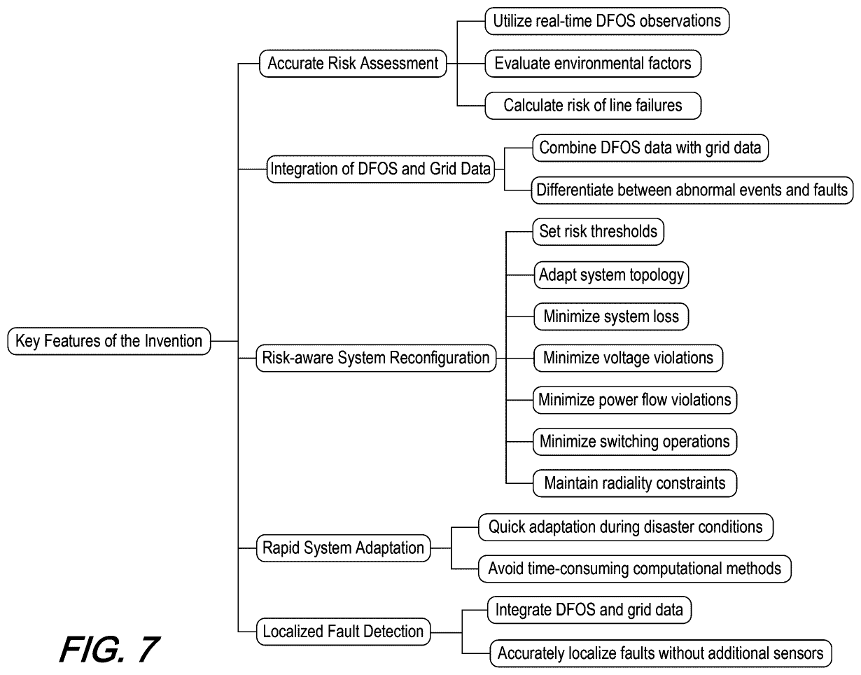

FIG. 7 shows illustrative features in hierarchical format of our inventive approach, according to aspects of the present invention.

FIG. 8 is a schematic flow diagram showing illustrative flow of our inventive method according to aspects of the present disclosure.

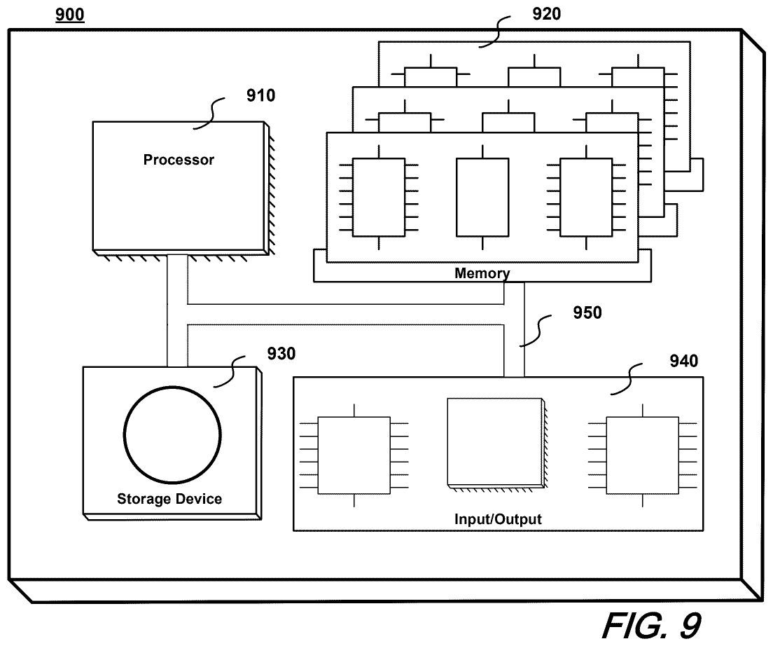

FIG. 9 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 900 as stored program control instructions.

Computer system 900 includes processor 910, memory 920, storage device 930, and input/output structure 940. One or more input/output devices may include a display 945. One or more busses 950 typically interconnect the components, 910, 920, 930, and 940. Processor 910 may be a single or multi core. Additionally, the system may include accelerators etc., further comprising the system on a chip.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 920 may store data and may be a computer-readable medium, such as volatile or non-volatile memory. Storage device 930 may provide storage for system 900 including for example, the previously described methods. In various aspects, storage device 930 may be a flash memory device, a disk drive, an optical disk device, or a tape device employing magnetic, optical, or other recording technologies.

Input/output structures 940 may provide input/output operations for system 900.

While we have presented our inventive concepts and description using specific examples, our invention is not so limited. Accordingly, the scope of our invention should be considered in view of the following claims.

1. A computer implemented method for evaluating risks and localizing faults in an electrical distribution grid, the method employing both distributed fiber optic sensing data and electrical distribution grid data, the method comprising:
by the computer:
acquiring DFOS data indicative of environmental conditions experienced by the electrical distribution grid, the DFOS data collected by a DFOS system;
acquiring real-time data from existing grid sensors;
utilizing the acquired DFOS data, determine risk associated with different zones within the electrical distribution grid; and
determine the probability of electrical line failures based upon an intensity and duration of the environmental conditions experienced by the electrical distribution grid.

2. The computer implemented method of claim 1 further comprising updating the determined risk to reflect latest environmental conditions experienced by the electrical distribution grid.

3. The computer implemented method of claim 2 further comprising setting a risk intensity and duration threshold for determining any necessity to reconfigure the electrical distribution grid.

4. The computer implemented method of claim 3 further comprising initiating, when the determined risk exceeds the set risk intensity and duration thresholds, a pre-fault electrical distribution grid reconfiguration such that high-risk zones are avoided during electrical distribution through the electrical distribution grid.

5. The computer implemented method of claim 4 further comprising adapting the electrical distribution grid to reroute electrical power flow away from high risk zones.

6. The computer implemented method of claim 5 further comprising differentiating, from DFOS data and grid data, abnormal events and actual faults occurring in the electrical distribution grid.

7. The computer implemented method of claim 6 further comprising localizing, using both DFOS data and electrical distribution grid data, faults that have occurred in the electrical distribution grid.

8. The computer implemented method of claim 7 further comprising verifying, that an adapted topology meets operational requirements with voltages and power flows within acceptable ranges as compared to predetermined acceptable ranges.
